(19) United States
(12) Patent Application Publication
(10) Pub. No.: US 2015/0266566 A1
(43) Pub. Date: Sep. 24, 2015

(54) METHOD FOR DRIVING LANDING GEAR WHEELS OF AN AIRCRAFT AND LANDING GEAR APPARATUS

(71) Applicant: Sergey Ivanovich Ivandaev, Moscow (RU)

(72) Inventor: Sergey Ivanovich Ivandaev, Moscow (RU)

(21) Appl. No.: 14/426,911

(22) PCT Filed: Sep. 24, 2012
(86) PCT No.: PCT/RU2012/000778

§ 371 Date: Jun. 2, 2015

(51) Int. Cl. B64C 25/40; B64C 25/58; B64C 25/42; B64C 25/34

(52) U.S. Cl. CPC B64C 25/405; B64C 25/34; B64C 25/58; B64C 25/42

(57) ABSTRACT

In the proposed method, each landing gear wheel is rotated with the aid of one of the radial- or axial-type air turbines which are mounted on said wheel, rotate in opposite directions and to which compressed air from the main engines or from an auxiliary power-generating plant of the aircraft is fed. The wheels are spun by one of the turbines before landing or during forwards movement on the ground, while the other turbine is used for braking after touchdown, and also for reversing and for turns when manoeuvring. Air is also used for bleeding and cooling a wheel brake. Non-communicating air collectors of the turbines are connected by a telescopic pipe, which is fastened on a landing gear leg, via control valves to on-board compressed-air sources. Brake stator discs have through-channel sectors and are nozzle diaphragms, while rotor discs have through-channels arranged uniformly around the circumference and are working wheels of the axial turbine. Nozzle apparatuses of the radial turbine are mounted on the stator, while the working wheel is mounted on the internal rim of the landing gear wheel. The nozzle apparatuses are connected by sector air ducts to the corresponding air collectors.

The invention pertains to aviation equipment, specifically, methods of driving the wheels of an aircraft landing gear to equalize the circumferential velocity of each wheel with the velocity of the airplane during touchdown and for its movement on the ground.

There is a known method of preliminary acceleration of the wheels of an aircraft landing gear (Kos'minykh S. V., RF Patent No. 2152334), consisting in the use of pocket blades of variable geometry, made of an elastic flexible material, on the lateral surface of the wheel tire. During takeoff, the blades squeeze against and hold the wheels in the folded condition, and during landing they release them, for example, by means of electromagnets and springs, for acceleration of the wheels after deployment of the landing gear.

The drawback of the method is the difficulty of changing and checking the acceleration of the wheel to the necessary angular velocity. In multiple-wheel landing gears, the turbines of the front wheels of the carriage shield the wheels behind them from the air flow. As a result of this shielding, the likelihood of an equally effective acceleration of all the wheels of the carriage is reduced. Furthermore, this method requires a fabrication and attachment of the pocket blades during the fabrication of the tire, or in the course of its shaping, or by attachment with the method of vulcanization, as well as bonding, i.e., a change in the actual tire manufacturing process.

There is a known method of preliminary acceleration of the wheels of an aircraft undercarriage (Belyayev V. I., RF Patent No. 2 384 467), consisting in the feeding of air to the turbines mounted on the landing gear wheel bodies from air intakes (diffusers) or from a high-pressure accumulator, in particular, a gas cylinder, connected by pipelines to nozzle boxes connected to the turbines.

The drawback of the method is the bulkiness of the design of the air intake devices, requiring special measures for their retraction along with the landing gear after takeoff. During takeoff, such air intakes create substantial aerodynamic drag, which slows down the airplane, and does not accelerate it by virtue of the wheel drive. The cylinder system is large and heavy and needs charging with high-pressure air (gas) before flight, which complicates the technical maintenance of the airplane.

There is a known method of braking and maneuvering (Steven Sullivan, RF Patent No. 2 403 180) according to which a wheel drum motor/generator is used as a motor prior to touchdown, in order to coordinate the circumferential velocity of the tires with the relative ground speed so that when touchdown occurs there is a minimal difference between these two speeds. The drive unit of the airplane wheels is also used for its movement on the ground and during takeoff. The wheel drum motor/generator is an electric disk motor, whose disks are used at the same time as the friction brake disks.

The drawback of the method is the heavier weight of the landing gear due to the electric motors and the airplane itself due to special onboard high-power accumulators in the case of accumulating the recoverable braking energy. The creation of effective moments of electromagnetic forces sufficient for movement of the airplane while maneuvering in the small volume of the wheel hub is technically difficult and substantially complicates the fabrication, operation, and repair of the wheel drive unit.

The problem which the proposed invention should solve is the accelerating of the wheels of a landing gear to the necessary rotational speed that prevents skidding of all the wheels relative to the landing strip, with no impact at the moment of contact and minimal tire wear, and also an autonomous movement of the airplane on the ground by virtue of the wheel drive unit. An additional problem is to prevent the formation of so-called “rubber tire marks” on the takeoff and landing strips of airports, resulting from the burnt rubber of the landing gear tires of airplanes touching down. A tire mark is left behind on the strip from the impact, stretching for a distance of up to 500 meters from first impact. Rubber tire marks are dangerous, since the layer of burnt rubber reduces the coefficient of adhesion of the tire to the concrete by a factor of two or more times, resulting in longer post-touchdown travel of the airplane.

The technical result achieved in the proposed invention is the possibility of equalizing the circumferential velocity of each tire with the speed of the airplane during landing and precise control of the rotational speed of each wheel of the landing gear carriage. An additional result of the invention is the prevention of the formation of “rubber tire marks” on the takeoff and landing strip, which lowers the adhesion of the airplane tires to the strip. Another technical result is the possibility of autonomous movement of the airplane around the air strip, even when the main engines are not operating, including small-radius 180-degree turns by having the wheels of different landing gears turn in opposite directions and movement in reverse gear. Another technical result is a significant lowering of the stress on the friction brakes of the airplane, eliminating the danger of their overheating, and extending the service life of the friction brakes and tires.

The technical result of the invention is also achieved in that each wheel of the landing gear is rotated by means of one of two air turbines with opposite directions of turning, coaxial to the wheel. Compressed air from the main engines or from an auxiliary power-generating plant (APGU) of the aircraft is fed to one of the air turbines, depending on the required direction of rotation, by a system of pipelines. The air pressure in this process exceeds the atmospheric pressure, while the temperature is maintained at a level so that the temperature of the air behind the turbine does not exceed the permissible strength of the materials of the wheel drum and tires.

Another variant is to supply air to the air turbines of the wheels from an ejector, taking in atmospheric air, into whose nozzle air is supplied by a system of pipelines, the pressure of which exceeds atmospheric pressure, from the main engines of the aircraft or from the onboard APGU. The supply of air to the turbines from the ejector is done by a tap from the compressors of the main gas turbine engines of the aircraft, from the onboard APGU, or from the compressor of a turbocompressor, whose compressor and turbine are supplied air from taps of the main engines, or from the turbocharging system of the piston engines of the aircraft. Control of the acceleration of the wheel to the required speed of angular rotation of the wheel during landing is done by means of a control valve for the air supplied to the wheel turbine, at a signal put out by a comparison unit of the signals from the aircraft's speed sensor and the sensor of angular speed of rotation of the wheel.

The benefit of the proposed invention is a substantial increase in the braking ability of the wheels of the landing gear during standard and emergency braking, less danger of overheating of the brakes, a reliable autonomous of the aircraft about the air field, including reversing and negotiating low-radius turns, even when the main engines of the aircraft are not operating. Another benefit is reliable acceleration of all wheels of the landing gear to a circumferential velocity of the rim of the tires as close as possible to the landing speed of the aircraft.

The proposed method is explained by the drawings, where

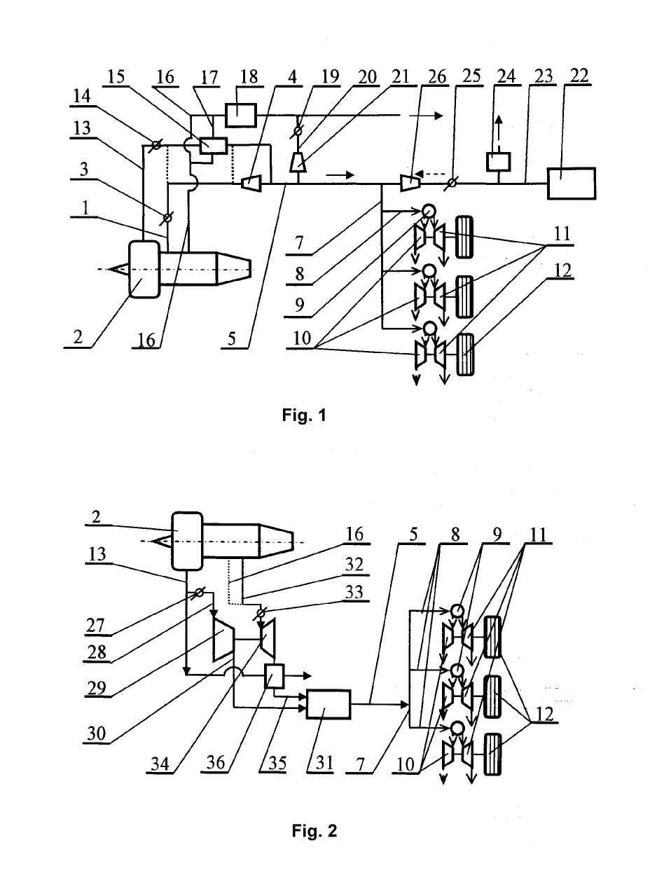

FIG. 1 and FIG. 2 show variants of the general scheme of the method which can be used for gas turbine engines, especially ducted-fan engines.

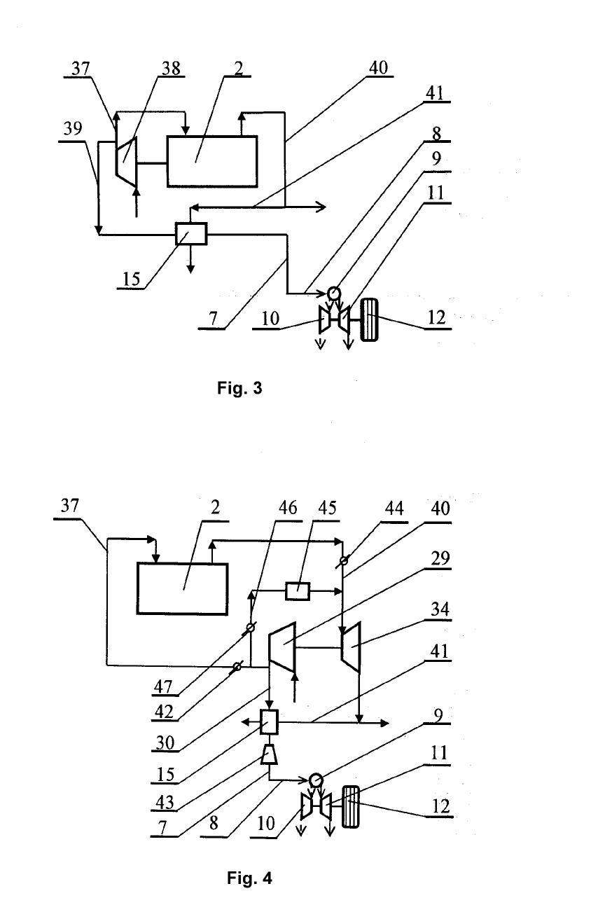

FIG. 3 shows the scheme of the method which can be used for piston engines with powered supercharger,

FIG. 4 for piston engines with turbocompressor, and

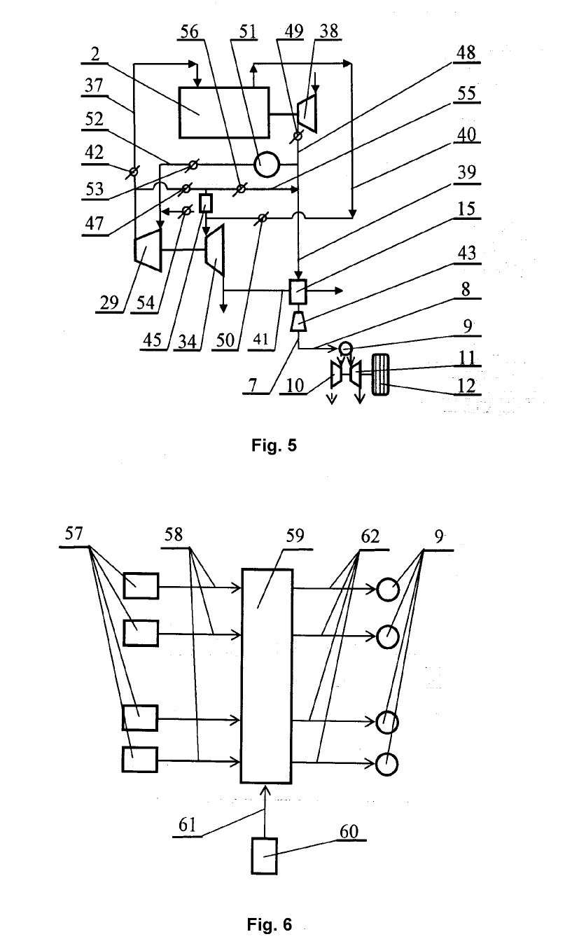

FIG. 5 for piston engines with powered supercharger and turbocompressor.

FIG. 6 shows a schematic for regulating the speed of rotation of the wheels of the landing gear.

The following regimes are possible when implementing the method in aircraft with gas turbine engines:
The main engines are not operating. The airplane is maneuvering independently on the flight field. Air from the onboard APGU is used to drive the wheels of the landing gear.
The main engines are operating. In this case, it is possible to drive the wheels for their acceleration prior to landing, braking of the airplane immediately after landing, maneuvering on the flight field before takeoff or after landing, including reversing, and takeoff of the airplane. In all these cases, air can be supplied to the collector of the landing gear by:
   tapping air behind the fan of a ducted-fan engine
   tapping of low-pressure air from the compressor of the engine
   tapping of high-pressure air from the compressor of the engine
   supplying air from the onboard APGU.

When implementing the variant of the proposed method in an airplane with gas turbine engines, as shown in FIG. 1 for a turbofan engine, air for the driving of the wheels of the landing gear is tapped from the pipeline 1 of regular air tap from the engine 2, which provides for the aircraft's own needs for compressed air of the engine 2. This air is supplied via the open valve 3 to an ejector 4, where the pressure and temperature of the flow are lowered by intake of atmospheric air. From the ejector 4, the air goes by pipeline 5 to the air collector 7 of the landing gear. From the air collector 7 of the landing gear, the air goes by a system of offtake pipes 8 across control valves 9 to one of the turbines 10 or 11 which drive the wheels 12 of the landing gear in rotation in opposite directions.

In another variant, air from the engine is tapped behind the fan stage of a turbofan engine and supplied by the pipeline 13, on which a valve 14 is mounted, to a heat exchange unit 15, where it is heated by the air of a higher pressure tap arriving from the engine 2 and supplied to the pipeline 5. The broken line indicates the pipelines along which air can be supplied from the pipeline 1 across the heat exchange unit 15 for its heating before going to the ejector 4.

Some of the high-pressure air tapped from the engine 2 by the pipeline 16 goes to the heat exchange unit 15 along the pipeline 17, where it is used to heat the air tapped behind the fan stage. After this, together with the main air flow of pipeline 16 it is supplied to the heat exchange unit 18 of the air conditioning system (not shown in FIG. 1) and other systems of the aircraft. In the variant of using air from high-pressure taps, it is supplied to the pipeline 5 across the open valve 19 with valves 3 and 14 closed via pipeline 20 to the ejector 21, in which the pressure and temperature of the flow are lowered by intake of atmospheric air. From the ejector 21, the prepared air goes by pipeline 20 to the pipeline 5 and on to the air collector 7 of the landing gear.

When the main engines are not operating, air is supplied to the air collector 7 again with valves 3, 14 and 19 closed from the onboard auxiliary power plant 22 of the aircraft. Air from the power plant 22 goes by pipeline 23 to the heat exchange unit 24 to prepare the air for the air conditioning system (not shown in FIG. 1). Through the open valve 25, air from the pipeline 23 goes to the air ejector 26, in which the pressure and temperature of the flow are lowered by intake of atmospheric air. From the ejector 26, the prepared air goes to the pipeline 5 and onward to the air collector 7 of the landing gear.

When the aircraft is operating and does not need an air supply to the air collector 7 of the landing gear, the valves 3, 14, 19 and 25 are closed.

In event of accelerating the wheels prior to landing, with valve 14 open, air is tapped behind the fan stage of a turbofan engine, after which is goes by pipeline 13 to the heat exchange unit 15 and onward to the pipeline 5 and collector 7. From the collector 7, by the offtake pipes 8, the air goes to the control valves 9, from which it is fed to the air turbines 11, which accelerate the wheels of the landing gear and equalize the circumferential velocity at the wheel rim and the landing speed of the airplane. After the wheels touch down on the landing strip, the control valves 9 switch the air feed to the air turbines 10 having an opposite direction of rotation to the turbines 11, and a braking of the wheels is done by means of the turbines 11, partly reducing the load on the friction brakes of the wheels. By switching the control valves 9, air goes to the air turbines 11 to carry out a movement and maneuvering on the strip.

FIG. 2 shows a variant embodiment of the method using a turbocompressor. For the driving of the landing gear wheels, some of the air is tapped from the pipeline 13, where it is supplied from the external duct of the fan engine 2, and it is supplied across the open valve 27 to the pipeline 28. From the pipeline 28, the air goes to the compressor 29 of the turbocompressor, from whence it is directed by pipeline 30 to the mixer 31. Air of high (greatest) pressure from the engine 2 is supplied from pipeline 32 across the open valve 33 to the turbine 34 of the turbocompressor, after which it is directed by pipeline 35 [to] the heat exchange unit 36. The air cooled in the heat exchange unit 36 goes to the mixer 31. The air in the heat exchanger 36 is cooled by the air of the second duct of the engine 2, which supplies [it] to the heat exchange unit 36 by pipeline 13. After the mixing of the two streams in the mixer 31, air with specified temperature and pressure is taken by pipeline 5 to the air collector of the landing gear 7. From the air collector 7 of the landing gear, the air goes by a system of offtake pipes 8 across control valves 9 to one of the turbines 10 or 11 driving the wheels 12 of the landing gear in opposite directions of rotation. The broken line in FIG. 2 shows the pipeline 16 of FIG. 1, corresponding to an intermediate high-pressure tap which can be used as a variant for supply of air to the turbine of the turbocompressor.

The following regimes are possible when implementing the method in aircraft with piston engines:
The main engines (engine) are not operating. The airplane is maneuvering independently on the flight field. Air from the autonomously operating turbocompressor is used to drive the wheels of the landing gear.
The main engines are operating. In this case, it is possible to drive the wheels for their acceleration prior to landing, braking of the airplane immediately after landing, maneuvering on the flight field before takeoff or after landing. In all these cases, air can be supplied to the collector of the landing gear by:
   tapping air from the engine supercharging pipeline by the powered supercharger
   tapping of air from the engine supercharging pipeline by the compressor of the turbocompressor
   tapping of air from the intermediate air cooling pipeline between the powered supercharger and the compressor of the turbocompressor

When implementing the proposed method in an airplane with piston engine with powered compressor, as shown in FIG. 3, a portion of the air from the supercharging pipeline 37 of the piston engine 2 where air is forced in by the powered supercharger 38 is tapped and supplied by the pipeline 39 across the heat exchange unit 15 to the air collector 7 of the landing gear. From the air collector 7 of the landing gear, the air goes by a system of offtake pipes 8 across control valves 9 to one of the turbines 10 or 11 which drive the wheels 12 of the landing gear in rotation in opposite directions. In the heat exchange unit 15, the air is heated by a portion of the outgoing gases of the engine 2, which are tapped from the exhaust pipeline 40 and are sent by the pipeline 41 to the heat exchange unit 15.

When implementing the proposed method in an airplane with piston engine with turbocompressor, as shown in FIG. 4, a portion of the air from the supercharging pipeline 37 of the engine 2 with valve 42 open, where air is forced in by the compressor 29 of the turbocompressor, is tapped and supplied by the pipeline 30 across the heat exchange unit 15 to the nozzle of the air ejector 43. From the ejector 43, the air goes to the air collector 7 of the landing gear. From the air collector 43, the air goes by a system of offtake pipes 8 across control valves 9 to one of the turbines 10 or 11 which drive the wheels 12 of the landing gear in rotation in opposite directions. Outgoing gases of the engine 2 go by the exhaust pipeline 40 across the open valve 44 to the turbine 34 of the turbocompressor, rotating the compressor 29. The air is heated in the heat exchange unit 15 by the outgoing gases of the turbine 34 of the turbocompressor, for which they are sent by the pipeline 41 to the heat exchange unit 15.

When the main engine 2 is not operating, the valves 42 and 44 are closed and the turbogenerator operates independently of the main engine 2 thanks to the use of the combustion chamber 45. In this case, air behind the compressor 29 is tapped from the pipeline 37 into the pipeline 46 across the open valve 47 and supplied to the combustion chamber 45 of the turbocompressor. The hot gases from the combustion chamber 45 go to the pipeline 40, and from this to the turbine 34. A portion of the spent gases from the turbine 34 is sent to the heat exchange unit 15 via the pipeline 41.

FIG. 5 shows a diagram implementing the method in an airplane with piston engine with powered supercharger and turbocompressor. For the driving of the landing gear wheels, a portion of air is tapped from the pipeline 48 of the powered supercharger 38 across the open valve 49 and supplied via the pipeline 39 across the heat exchange unit 15 to the nozzle of the air ejector 43. From the air ejector 43, the air goes to the air collector 7 of the landing gear. From the air collector 7 of the landing gear the air goes by a system of offtake pipes 8 across control valves 9 to one of the turbines 10 or 11 which drive the wheels 12 of the landing gear in rotation in opposite directions.

The outgoing gases of the engine 2 go to the turbine 34 of the turbocharging unit by the exhaust pipeline 40 across the open valve 50. A portion of the outgoing gases from the turbine 34 goes by the pipeline 41 to the heat exchange unit 15, where they heat the air before it is supplied to the nozzle of the ejector 43. The main portion of the air from the pipeline 48 of the powered supercharger 38 is cooled in the intermediate cooler 51 and sent by pipeline 52 across the open valve 53 to the compressor 20 of the turbocompressor, after which it is compressed in the compressor 29 of the turbocompressor and sent by pipeline 37 to the engine 2 across the open valve 42.

When the main engine 2 is not operating, the valve 42 on the pipeline 37 and the valve 49 are closed. Air is supplied to the compressor 29 of the turbocompressor across the open valve 54 of the turbocompressor from the atmosphere, while the pipeline 52 is closed by the valve 53. Compressed air behind the compressor 29 is taken from pipeline 37 via pipeline 55 across the open valves 47 and 56 to the pipeline 39. From pipeline 39, air is sent across the heat exchange unit 15 to the nozzle of the air ejector 43 and onward to the air collector 7 of the landing gear. From the air collector 7 of the landing gear, air is sent by the system of offtake pipes 8 across the control valves 9 to one of the turbines 10 or 11 which drive the wheels 12 of the landing gear in rotation in opposite directions. A portion of the air from the pipeline 55 is supplied to the combustion chamber 45 of the turbocompressor, after which the hot gases are directed to the turbine 34, from whence the spent gases go to the heat exchange unit 15 via the pipeline 41.

FIG. 6 shows the diagram for regulating the speed of rotation of the wheels of the landing gear. Signals from the sensors 57 of the speed of rotation of the wheels are sent by lines 58 to the onboard computer 59. Also arriving at the onboard computer 59 is the signal from the sensor 60 of aircraft speed via line 61. In the computer 59, after comparing the signals from the sensors 57 and 60, control signals are worked out and sent by lines 62 to the corresponding control valves 9, which carry out the feeding of air to the wheel turbines.

The mathematical validation of the proposed method is presented by the example of the airplane II-96-300, having four PS-90A engines and two main landing gears, each of which has three pairs of wheels mounted on it.

### EXAMPLE 1

### Acceleration of the Wheels Before Landing

The mathematical evaluations of the possibility of implementing the proposed device are presented with respect to the parameters of the airplane IL-96-300, having tires 1300×480×560. Say that the wheel of the landing gear is accelerated to a circumferential speed equal to the landing speed of the airplane V=250 kmh=69.4 ms. Then the circumferential speed of rotation of the wheel will be equal to ω_{W}=V/R=106.84 l/s, where R is the radius of the tire, equaling 650 mm. The number of revolutions of the wheel is n=1020 rpm. The kinetic energy of rotation of the wheel will be equal to E_{W}=Jω_{W}²/2, where J is the moment of inertia of the wheel. We shall assume that the moment of inertia of the wheel in the assembled state is equal to the sum of the moment of inertia J1 of the wheel without tire and the moment of inertia J2 of the tire. The mass of the IL-96-00 wheel assembled with the tire (S. S. Kokonin, Ye. I. Kramarenko, A. M. Matveyenko. “Fundamentals in the design of aviation wheels and brake systems”, M: MAI, 2007, 263 pp.) is 322 kg, while the mass of the tire itself is equal to 106 kg, i.e., the mass of the wheel without the tire is equal to 216 kg. Hypothetically considering the wheel without the tire as a homogeneous disk, and the tire itself as a thick-walled homogeneous tube, we have:

J1=m1R1²/2=8.47 kgm², J2=m2(R²+R1²)/2=26.55 kgm², J1+J2=35.015 kgm².

Then the kinetic energy of the accelerating wheel is equal to approximately 200 kJ. We shall assume that the time to accelerate the wheel from the state of rest to the required velocity is equal to 30 s. Then a sufficient power for the air turbine to drive the wheel is equal to 6.7 kW, while the total power for the driving of all 12 main wheels is 80 kW. For the further calculations, it is assumed that the air turbine of the landing gear wheel is subsonic, single-stage, radial with partial air supply. The diameter of the radial gap between the nozzle and the working blades is equal to 0.6 m, the blade height is 0.01 m, the degree of partiality is 0.2, and the turbine efficiency is 0.45. All of the calculations are based on the condition that the air temperature behind the turbine should not exceed 125° C. (S. S. Kokonin et al.) during the movement of the wheels.

### EXAMPLE 2

### Tapping of Air Behind the Fan Stage

The least air pressure in the taps of the engine PS-90A (A. A. Inozemtsev, Ye. A. Konyayev, V. V. Medvedev, A. V. Nerad'ko, A. Ye. Ryasov, “The aviation engine Ps-90A”, M, 2007, 319 pp.) is the air pressure behind the fan. In takeoff conditions, the degree of pressure rise is equal to 1.67, in cruising conditions it is 1.75. We shall use an average value of 1.7. This pressure gradient can be drawn down in a single-stage subsonic turbine.

We shall assume that the overall power of the drive of all wheels of the airplane is equal to 360 kW. Then the air tap from one engine (for three landing gear wheels) behind the fan stage is equal to 3.35 kg/s. For an overall air flow through the internal duct of the engine equaling 504 kg/s and a bypass ratio of the engine of 4.5, this flow rate is less than 0.15% of the air flow rate in the outer duct. The air temperature behind the wheel turbines is 120.4° C. The air temperature of the tap can be estimated at 358 K, the foregoing numbers having been found in the assumption that the air of the tap is heated in a heat exchanger by 62° C. to 420 K. If a tap is used from the second duct of the engine one can have a large air flow rate. For example, assuming the power of the wheel brake turbine is 500 kW, the blade height is 50 mm, a full supply of air to the working wheel of the turbine and a turbine efficiency of 0.88, then the air flow rate through one wheel becomes 9.53 kg/s. The tapping flow rate from one engine is equal to 28.58 kg/s, which amounts to a 1.26% air flow rate in the second duct of the engine. The mean braking power of the II-96-300 aircraft (S. S. Kokonin et al.) is equal to 1471 kW; thus, the power of the braking turbine is 34% of the braking power. This lets us rule out overheating of the friction brakes.

For the use of a subsonic turbine stage, the high-pressure air from the taps of the engine or APGU is directed to the ejector, lowering the air pressure in front of the turbine but increasing its flow rate. The calculations were done for a sonic ejector at critical mode (G. N. Abramovich, “Applied gas dynamics”, M: Nauka, 1969, 824 pp.).

### EXAMPLE 3

### Use of Air from the Onboard APGU

When using the APGU of the TA-12 as air source (air flow rate equal to 1.6 kg/s, pressure 4.9 kg/cm², temperature 250° C., see “Aviation engine design”, Encyclopedia, M., 1999, 300 pp.), the overall flow rate of the air after the ejector is equal to 2.97 kg/s, the power of the wheel turbine is 7.2 kW, and the overall power of the landing gear wheels is 86.3 kW. The temperature of the air behind the air turbine is 118.3° C. It is assumed that the air after the TA-12 is directed at once to the ejector without changing its temperature. The equivalent power of the TA-12 is equal to 287 kW and corresponds to the expansion of the air of the system in the turbine with an efficiency of 0.92. Such a conspicuous difference between the rated power of the drive turbines and the equivalent power is explained by the low efficiency of the air turbines of the wheels, assumed as being 0.45, which is due to the partial air supply to the turbine wheel.

### EXAMPLE 4

### Tapping of Air from the Retaining Stages of a Compressor

The air pressure of the tap is equal to approximately 2.5 kg/cm² and the temperature is roughly 403 K. In this case, with wheel turbine power of 30 kW and heating of the tap air to 460 K, the flow rate of the air being tapped from the engine is equal to 2.32 kg/s, which increases the standard tap by approximately 21%. The air temperature behind the wheel turbine is equal to 118° C. But if the tap air in front of the ejector is not heated, then the tap flow rate increases to 2.62 kg/s, and the temperature behind the turbine will be equal to 80° C.

### EXAMPLE 5

### Tapping of Air from a High-Pressure Compressor (HPC)

The degree of pressure increase in the engine PS-90A is 35, while the degree of pressure increase in a tap behind stage VII of the HPC can be estimated at 27.77. When the tap air is cooled down to 600 K, the flow rate of air tapped from the engine at wheel turbine power of 30 kW is equal to 1.26 kg/s. This constitutes around 10% of the air flow rate for cooling of the nozzle and working blades (approximately 12.39 kg/s), tapped behind stage VII. The air temperature behind the drive turbine in this case is equal to 120.7° C.

There is a known device for braking and maneuvering of an aircraft (Steven Sullivan, RF Patent No. 2 403 180) according to which an electric disk motor/generator is installed in the wheel drum, whose disks at the same time are the disks of the friction brake.

The drawback of the device is a heavier landing gear due to the electric motors and a heavier airplane itself due to the special onboard high-power accumulators if the recuperated braking energy is accumulated. The creation of effective moments of electromagnetic forces sufficient for movement of the airplane while maneuvering in the small volume of the wheel hub is technically difficult and substantially complicates the fabrication, operation, and repair of the wheel drive unit.

There is a known aircraft landing gear wheel apparatus (Rod F. Soderberg, UK Patent No. 2436042 B), in which special windings or coils, or electrically magnetizable materials, are secured inside the wheel drum or shaped as the wheel stator and rotor, eliminating the brake disks, and producing the rotational forces acting on the wheel.

The drawback of the apparatus is a heavier landing gear on account of the windings of the electric motors situated inside the wheel drum and the severe temperature conditions in which these windings need to operate during intense braking, especially in takeoff abort mode just prior to the airplane lifting off from the landing strip. According to data (S. S. Kokonin et al.), when carrying out consecutive landings, especially during short flights, the brake temperature without cooling may reach 600° C., which requires high-temperature electrical insulation materials for the windings and the organization of a supplemental cooling for them. Furthermore, these insulation materials should work reliably under conditions of substantial impact and vibration stress. All of this in the case of high-power braking apparatus results in major design, material science, and operational problems.

There is a known device for the wheel of a means of transportation (Parfenov V. N., Maksimov V. A., Yamkovenko D. P., Klinkov V. P., Nikolayev V. A., RF Patent No. 2222473), in which a multidisk brake in order to improve the cooling is placed in a cooling chamber communicating with the atmosphere, in addition to which an annular receiver is formed, whose entrance communicates with an air supercharger, and the outlet communicates via outlet openings with the cooling chamber and with the cavity between the brake cylinder assembly and an annular partition.

The drawback of the proposed device is the cooling of the set of brake disks by blowing cooling air only on the cylinder and tail parts of the disks in the set and not utilizing the gaps between the movable and immovable disks in the braked condition of the brake due to their small size. This lowers the cooling rate of the friction brake.

There is a known device for the wheel of a means of transportation (Klod Ankur, Ivon Ankur, RF Patent No. 2126503) in which for purposes of cooling the rotor disks have interior channels for the passage of air arriving through an internal opening in the disks along the axis of the wheel. To improve the air arrival, an axial slit channel emerges into a housing secured to the immovable part of the wheel, whose open part is directed against the oncoming air flow when the means of transportation is moving. It is proposed to use this device as well for accelerating the wheels of an airplane prior to landing in the assumption that the rotor disks will act like centrifugal air turbines.

The drawback of such a device is the lack of sufficient space between the periphery of the rotor disks and the rim portion of the wheels, which could provide a free exit of the air from the working wheels, and thus its flow rate and the turbine power. Furthermore, in the nonbraked condition of the wheel, there are gaps between the stator disks and the rotor disks, through which air will flow bypassing the channels in the rotor disks. This substantially reduces the possibility of accelerating the heavy wheel of the airplane by virtue of the rotor disks working as centrifugal air turbines. The drawback of such a braking device for the cooling of the disks is the ineffective cooling during inadequate speed of movement of the means of transportation.

The problem which the invention proposes to solve is the creation of a powerful drive for the landing gear wheels of an aircraft, enabling an acceleration of the wheels before landing, partial braking of the wheels after landing, air field maneuvering and braking, including travel in reverse and small-radius turns. An additional problem is to afford the possibility of autonomous maneuvering of the airplane on the ground before its main engines are started. The proposed invention is also addressed to solving the problem of reducing the wear on the tires, eliminating “tire marks” on the takeoff and landing strips of airports, and providing an intensive cooling of power-hungry brakes to shorten their cooldown time.

The technical result which can be achieved in the declared invention is the possibility of realizing a landing gear wheel drive unit with altered direction of rotation and sufficient power not only for prelanding acceleration of the wheels, but also both regular and emergency braking and air field maneuvering, including small-radius turns, even when the main engines are not operating. Another technical result is to increase the service life of the friction brakes and tires, to increase the operating reliability of rubber tires, to reduce their wear and eliminate “tire marks” on the takeoff and landing strips of airports. As a result of the forced cooling of the brakes, the restrictions are eliminated on an airplane performing many short-haul flights, due to the need for the brakes to cool down to a permissible temperature.

The technical result of the invention is accomplished by securing to the shock absorbing strut of the landing gear, in parallel with it, a telescoping pipeline for supply of air to the landing gear wheels, the immovable part of which is secured by a bracket to the shock absorber, while its extensible pipe, which is air-tight against the immovable part, is fastened by a bracket to the shock absorber piston. The telescoping pipeline at one end is connected to a source of compressed air on board the airplane, and at the other end to the air distributing collector of the landing gear wheels. To the air distributing collector are connected, by two offtake pipes for each wheel, on which control valves are mounted, annular wheel distributing collectors, not communicating by air, each of which is connected by sector air ducts to its radial or axial air turbine of the wheel drive unit, while the turbines have opposite directions of rotation.

Between the stator of the wheel and the first brake stator disk is installed an annular heat shield, by branch pipes uniformly distributed over the width of the air supply sector and installed in the stator and the heat shield; the cavity between the heat shield and the first stator disk is connected by the sector air ducts to the air collector of the brake cooling system. The annular wheel distributing collectors, the air collector of the cooling system, the sector air ducts and the brake cylinders are fabricated as a monolithic block, installed on the stator of each wheel.

Openings uniformly spaced about the circumference are located in the disk part of the wheel rim, opposite the last stator disk.

The sector air ducts of the annular wheel distributing collectors of the axial turbine are connected to their set of spring-loaded air supply sectors, uniformly arranged about the circumference and constantly pressed against the first braking sector disk. The spring-loaded sectors fit tightly into corresponding sector air ducts with ability to move parallel to the wheel axle together with the stator disk. Opposite the air supply sectors in the adjacent and following braking stator disks, except for the last one, there are constructed through-channel sectors so that the stator disks constitute nozzle boxes of the axial turbine with partial air supply to the working wheels.

In the last braking stator disk are constructed through channels so that the last stator disk constitutes an exit vortex gate with blades for partial air diversion from the last working wheel of the axial turbine. The angular width of the blade sectors of the stator disks increases from one disk to another in the direction of air movement. In the rotor disks of the wheel brake are constructed through channels uniformly distributed about the circumference, so that the rotor disks constitute the working wheels of the axial turbine with blades situated opposite the corresponding nozzle blades of the stator disks.

Openings uniformly spaced about the circumference are located in the disk part of the wheel rim, opposite the blade channels of the last stator disk.

In another variant of the device, the sector air ducts of the annular wheel distributing collector of the radial turbine are connected to their set of sectors of radial nozzle boxes, uniformly arranged about the circumference of their diameter, opposite which is mounted with a radial gap on the internal wheel rim the working wheel of a single-stage radial air turbine, or a multistage one with speed stages. The nozzle boxes of the radial air turbine, and in the case of using a multistage radial air turbine with speed stages also the immovable wheels of the guide blades, are fastened to a monolithic block mounted on the stator of each wheel.

In the thrust end face of the brake body, adjacent to the last stator disk, there are radial end-face channels, forming with the surface of the stator disk a system of radial cooling channels, communicating with slotted grooves in the brake body. Between the rotor disks are installed cylindrical rings, so that the outer cylindrical part of the rotor disks fits inside the rings with a slight gap. On the outer cylindrical surface of the rings are mounted spring sectors, situated in slotted grooves of the drum portion of the wheel rim and abutting against the tail pieces of the rotor disks, while there are systems of identical notches uniformly arranged about the circumference at the lateral end faces of the rings.

Between the stator disks are mounted cylindrical rings so that the fit into the internal cylindrical part of the stator disks with a slight gap, on the internal cylindrical surface of the rings are mounted spring sectors, situated in slotted grooves of the brake body and abutting against the tail pieces of the stator disks, and there are systems of identical notches uniformly arranged about the circumference at the lateral end faces of the rings.

The benefit of the proposed invention is a substantial increase in braking power of the landing gear wheels during standard and emergency braking, less risk of brake overheating, reliable autonomous movement of the airplane about the air field, including reversing and small-radius turns, even when the main aircraft engines are not operating. Another benefit is reliable acceleration of all landing gear wheels up to the circumferential velocity of the tire rim as close as possible to the landing speed of the airplane.

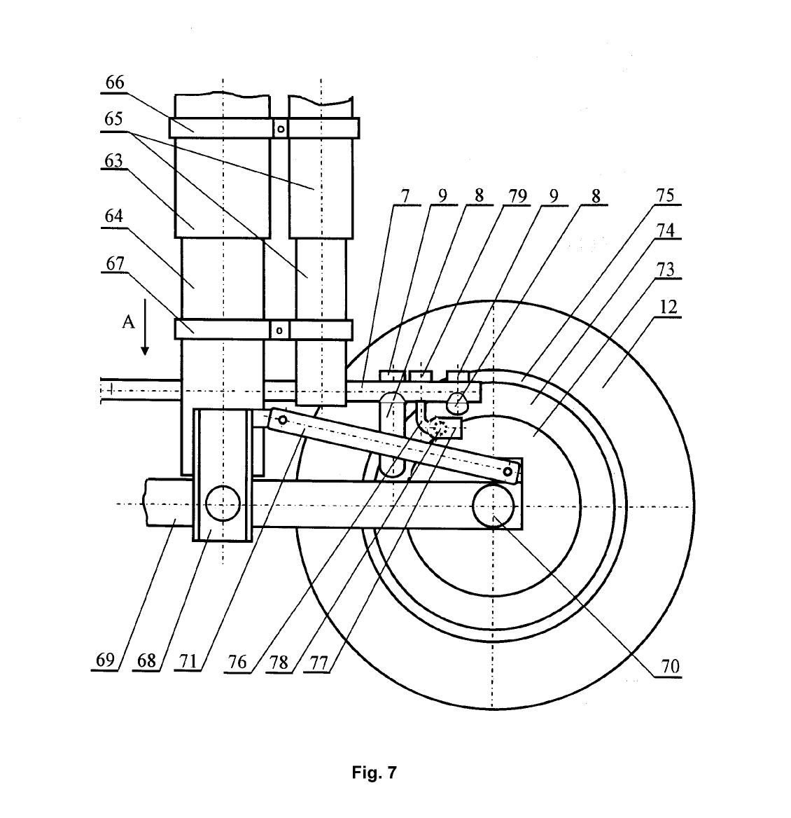

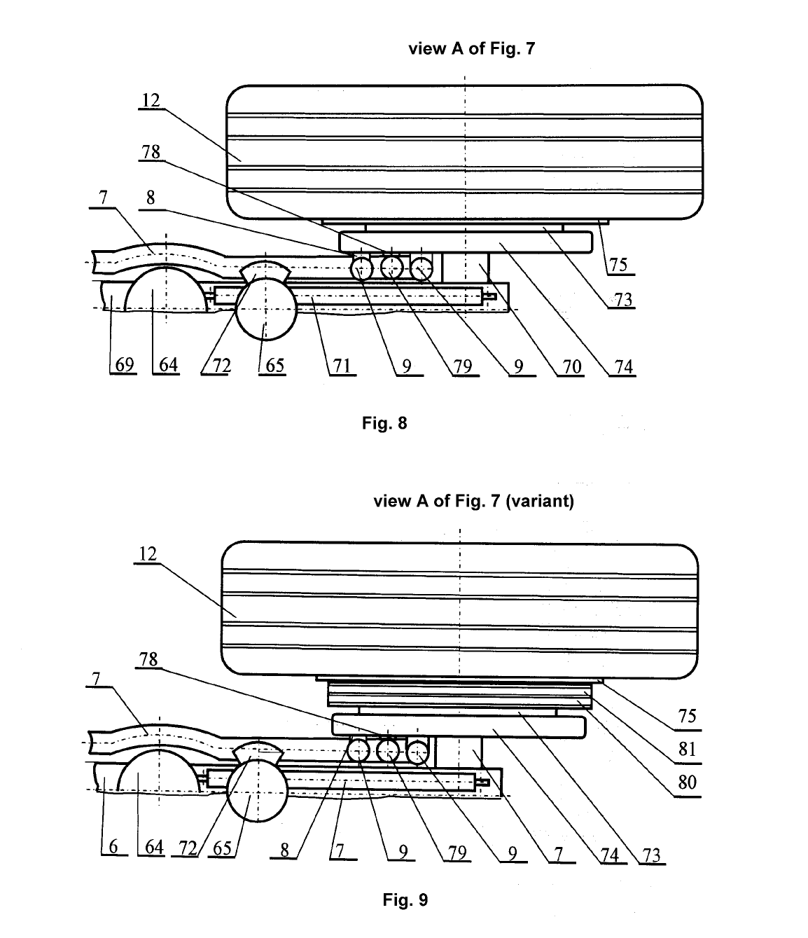

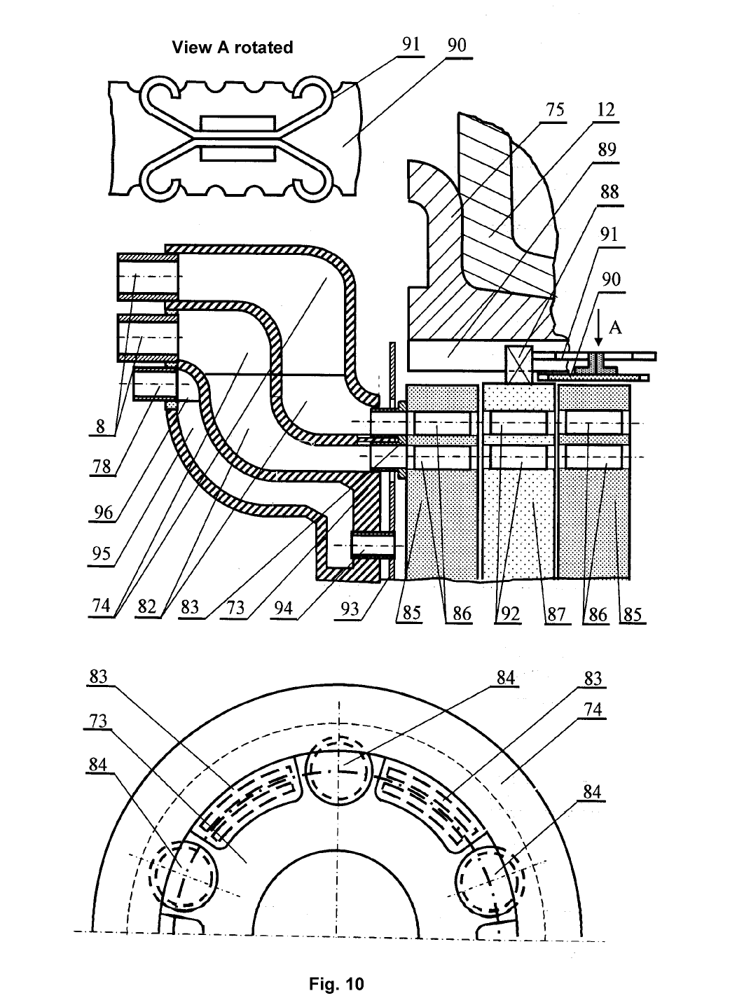

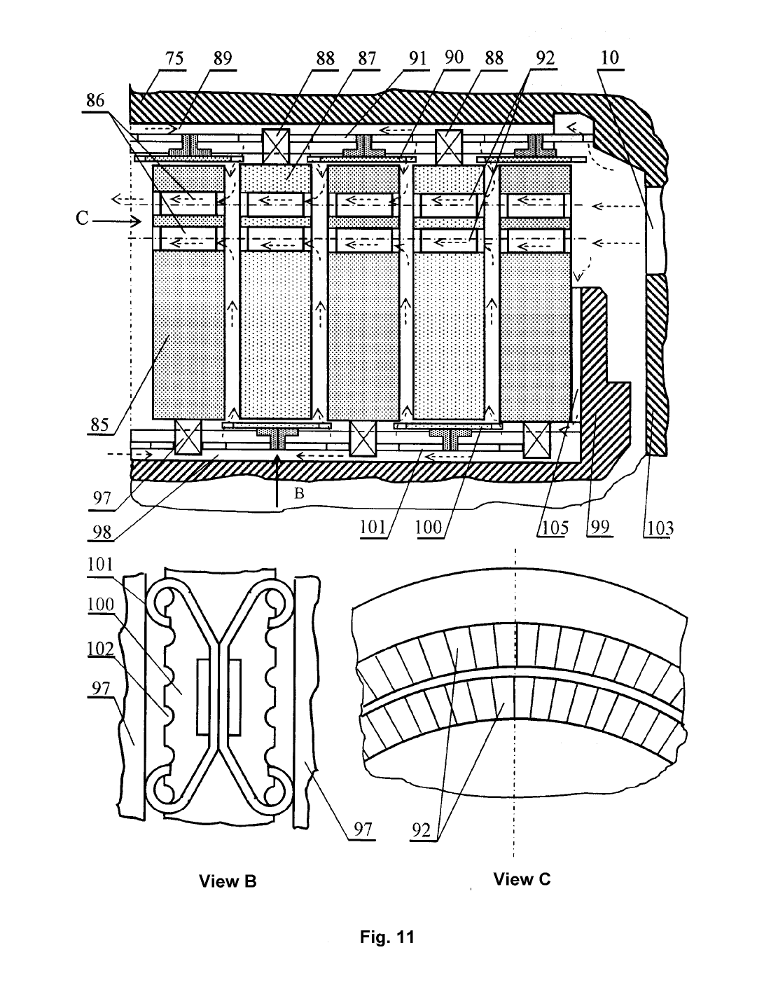

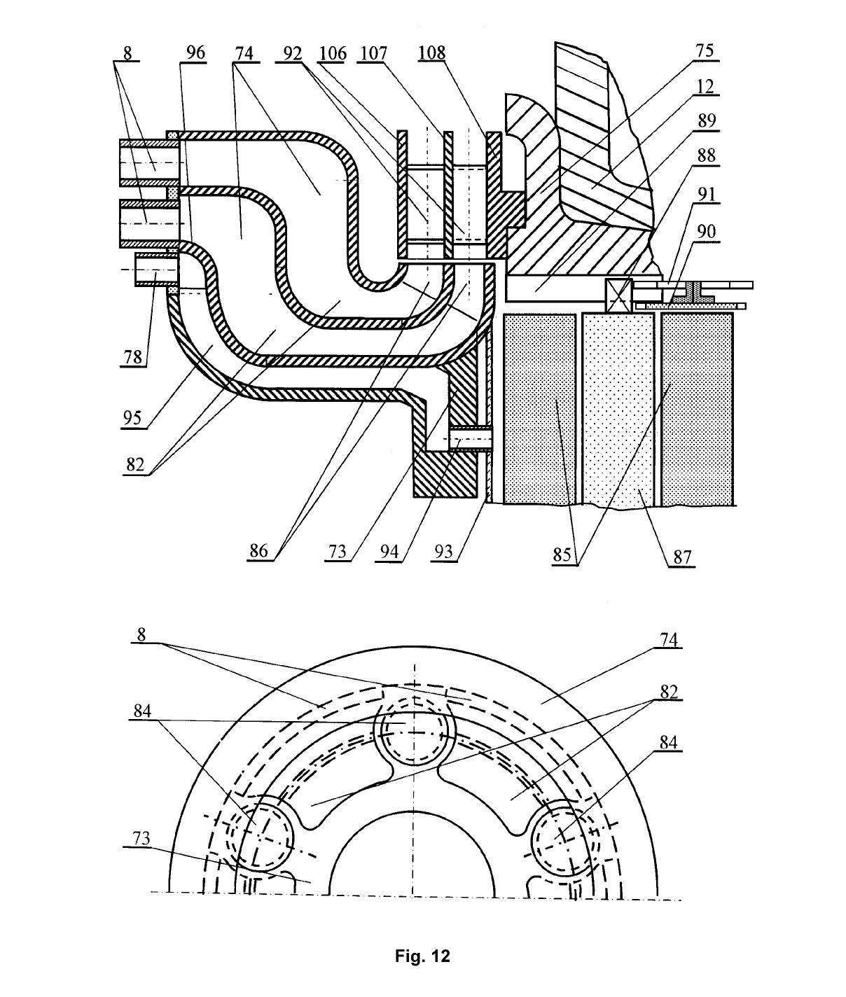

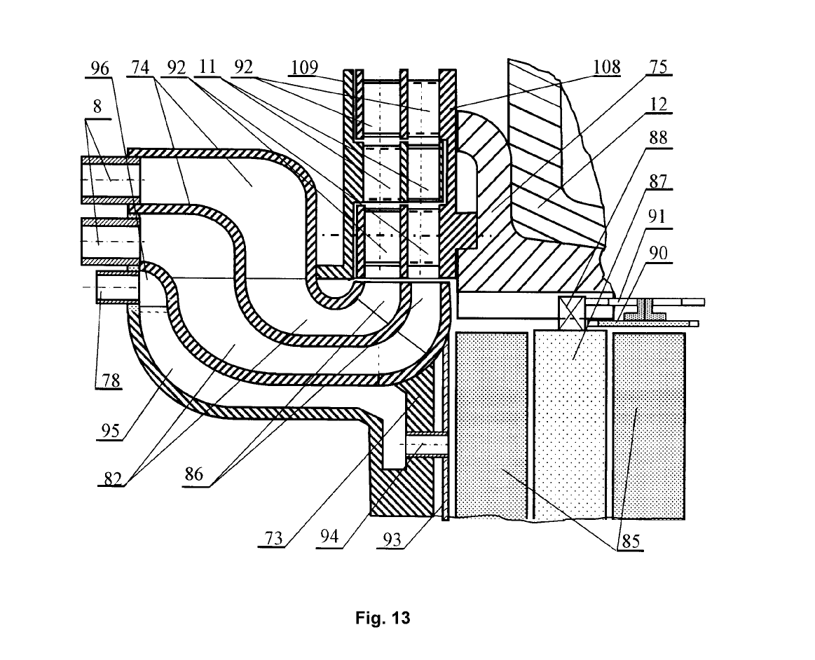

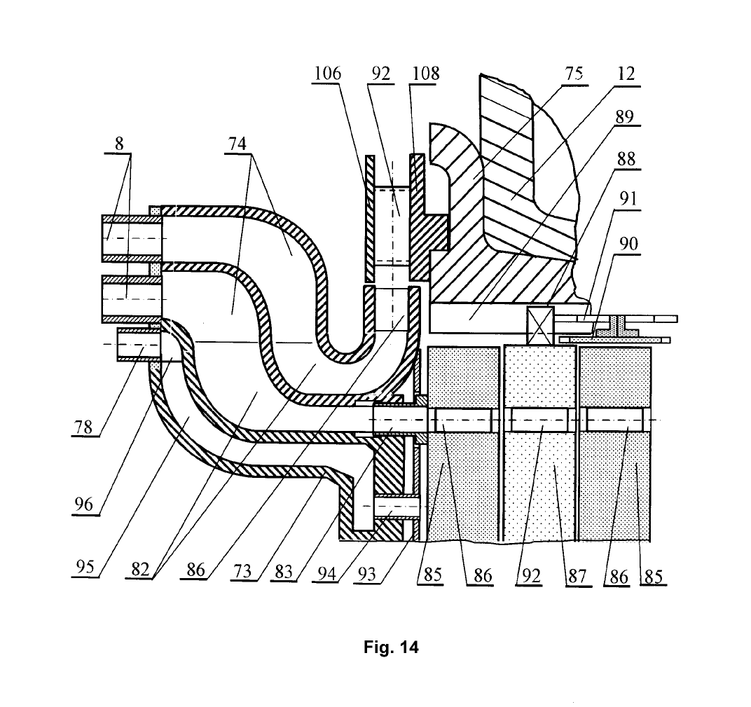

The proposed device is explained by the drawings, where FIG. 7 and FIG. 8 show a general view of the landing gear with air supply to the axial wheel drive turbines, FIG. 8 showing a view along arrow A of FIG. 7. FIG. 9 shows the same view as FIG. 8, but for the variant of radial wheel drive turbines. FIG. 10 shows a variant of the device with air supply to axial wheel turbines with a view of the wheel stator. FIG. 11 shows the axial wheel turbine device in the position of blowing on the disks with cooling air, FIG. 12 shows a diagram of the variant of the device with radial single-stage turbine, looking at the wheel stator, and FIG. 13 shows a variant of the diagram of FIG. 12 with two-stage radial turbines with two speed stages. FIG. 14 shows the device with axial and radial wheel turbines.

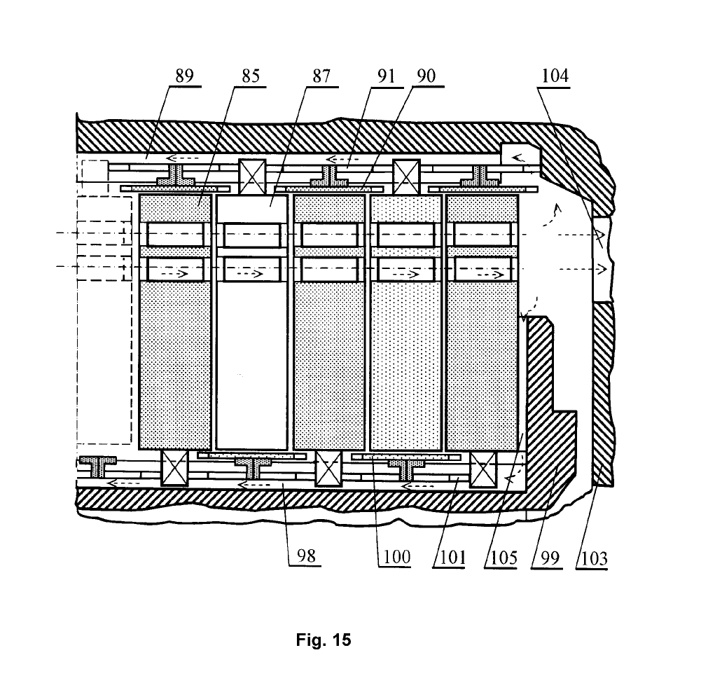

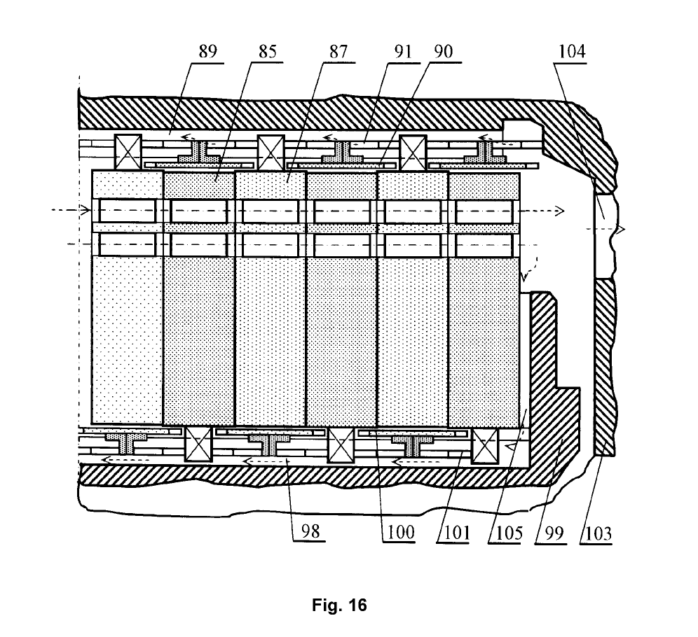

FIG. 15 shows the axial turbine device in the process of turbine driving of the wheels with no frictional braking, while FIG. 16 shows the axial turbine device in the process of friction and turbine braking.

FIG. 7 shows a diagram of the airplane landing gear with air supply to the wheel turbines. In parallel with the shock absorbing strut of the landing gear with shock absorber 63 and shock absorber piston 64 is mounted an extensible telescopic pipeline 65 for air supply to the landing gear wheels 12, which is connected to a source of compressed air (not shown in FIG. 7). The portion of the telescopic pipeline 65 which is immovable relative to the shock absorber 63 is secured to the shock absorber 63 by the bracket 66, and the extensible pipe of the telescopic pipeline 65, sealed air-tight against its immovable part, is fastened to the shock absorber piston 64 by the bracket 67. On the shock absorber piston 64 is secured by bracket 68 the rocker arm 69 of the carriage, on which are arranged the wheel axles 70 and the wheels 12. Between the fastening bracket 68 and the rocker arm 69 are installed the dampers 71 of the rocker arm 69.

The lower part of the extensible pipe of the telescopic pipeline 65 is connected to the air collector 7 of the landing gear by means of the pipe 72 (FIGS. 8 and 9). On the stator 73 of the wheel 12 are mounted the air collectors 74, which do not project beyond the rim 75 of the wheel 12, and which are connected by branch pipes 8 with control valves 9 to the air collector 7 of the landing gear. The air collector 7 of the landing gear is connected by the branch pipe 76 with control valve 79 to the nozzle of an ejector 77, whose entrance for ejected medium is connected by the branch pipe 78 to the air collector (not shown in FIG. 7) of the brake cooling system.

FIG. 8 is a view along arrow A of FIG. 7 for the variant of axial wheel turbines of the landing gear.

FIG. 9 is a view along arrow A of FIG. 7 for the variant of radial turbines of the landing gear wheels, showing the branch pipe 72 and the working wheels 80 and 81 of the radial turbines of the wheel 12 with opposite directions of rotation, mounted on the rim 75 of the wheel 12.

FIG. 10 shows the diagram of air supply to the axial turbines of the wheel. The branch pipes 8 for air supply fit into corresponding air collectors 74. The collectors 74 are connected by sector air ducts 82 to the sectors 83 for air supply to the nozzle boxes of the axial turbines. The air supply sectors 83 are tightly fitted to the corresponding sector air ducts 82 with the ability to move in parallel to the wheel axle when sinking into the air ducts 82 and emerging from them. The sector air ducts 82 with the air supply sectors 83 for the nozzle boxes of the turbine are arranged uniformly about the circumference between the brake cylinders 84.

The movable sectors 83 for air supply to the nozzle box are pressed by springs (not shown) against the braking stator disk 85 of the wheel brake. In the stator disk 85 adjacent to the sectors 83 and in the following stator disks 85 of the brake there are sectors of through channels uniformly distributed about the circumference, so that in meridianal cross section the stator disk constitutes a nozzle box with two-tiered blade 86 for partial air supply to the working wheel.

The braking rotor disks 87 are introduced by their tail pieces 88 into slotted grooves 89 in the drum portion of the wheel rim 75. Between the rotor disks 87 are installed cylindrical rings 90, so that the outer cylindrical part of the rotor disks 87 fits inside the ring 90 with a slight gap. On the outer cylindrical surface of the rings 90 are mounted spring sectors 91, arranged in slotted grooves 89 and abutting against the tail pieces 88 of the rotor disks 87. Systems of notches uniformly arranged about the circumference are present at the lateral end faces of the rings 90 (view A).

In the rotor disks 87 of the wheel brake, opposite the nozzle blades 86 of the stator disk 85, there are constructed blade channels, arranged about the entire circumference, so that in meridianal cross section the rotor disk constitutes a working wheel of the turbine with two-tiered blade 92, the blade tiers affording a rotation of the disk in different directions. The angular width of the blade sectors of the stator disks 85 increases in the direction of air movement, ensuring an increasing through section of the flow part of the axial turbine, whose working wheels are the rotor disks 87, while the stator disks 85 are nozzle diaphragms.

Between the wheel stator 73 and the first braking stator disk 85 is installed an annular heat shield 93. By branch pipes 94 uniformly arranged about the width of the air supply sector and installed in the stator 73 and the heat shield 93, the cavity between the heat shield 93 and the first stator disk 85 is connected by the sector air ducts 95 to the air collector 96 of the brake cooling system. The air collectors 74 and 96, the sector air ducts 82 with sectors 83 installed in them, the sector air ducts 95 and the brake cylinders 84 are constructed in the form of a monolithic block, mounted on the stator 73 of each wheel.

FIG. 11 shows the cross section of a wheel along the braking disk assembly, explaining the proposed device. The braking stator disks 85 are introduced by their tail pieces 97 into slotted grooves 98 in the brake body 99. Between the stator disks 85 are installed rings 100, such that they fit into the interior cylindrical part of the stator disks 85 with a slight gap. On the interior cylindrical surface of the rings 100 are mounted spring sectors 101, arranged in slotted grooves 98 and abutting against the tail pieces 97 of the stator disks 85.

At the lateral end faces 100 there are systems of notches 102 arranged uniformly about the circumference. In the disk portion 103 of the wheel rim, opposite the blade segments of the last stator disk 85, are openings 104 arranged uniformly about the circumference. In the thrust end face of the brake body 99, against which the last stator disk 85 presses, is a system of radial end-face grooves 105, forming with the surface of the stator disk 85 a system of radial cooling channels by which the cavity beyond the brake disk set communicates with the slotted grooves 98. At the same time, the cavity beyond the brake disk set communicates with the cavity of the slotted grooves 89, in which the tail pieces 88 of the rotor disks 87 are situated.

FIG. 12 shows a diagram of air supply to the radial wheel turbines. The air supply pipes 8 fit into corresponding air collectors 74, which are connected by sector air ducts 82 to the sectors of the nozzle diaphragms 86 of the radial turbines.

The working blades 92 of the radial air turbines, situated between the disks 106 and 107, 107 and 108, are in the form of a single working wheel with two flows, which is mounted on the rim 75 of the landing gear wheel. The blades of the working wheel, arranged between the disks 106 and 107, provide one direction of rotation, while the blades between disks 107 and 108 provide a rotation in the opposite direction. Between the stator 73 and the first braking stator disk 85 is installed an annular heat shield 93. By the branch pipes 94 uniformly distributed about the width of the air supply sector and installed in the stator 73 and the heat shield 93, the cavity between the heat shield 93 and the first stator disk 85 is connected via the sector air ducts 95 to the air collector 96 of the brake cooling system. The air supply sector air ducts 82 and 95 are arranged uniformly about the circumference and situated between the brake cylinders 84. The air collectors 74 and 96, sector air ducts 82 with nozzle blades 86, sector air ducts 95 and brake cylinders 84 are made in the form of a monolithic assembly, installed on the stator 73 of each wheel.

FIG. 13 shows the diagram of air supply to radial wheel turbines with speed stages. Here the working blades 92 of the radial turbines with two speed stages are installed on the disk 108, which is mounted on the wheel rim 75. On the nonrotating disk 109 are mounted the guide blades 110 of the speed stages. Between the first braking stator disk 85 and the stator 73 is installed an annular heat shield 93. By the branch pipes 94 uniformly distributed about the width of the air supply sector and installed in the stator 73 and the heat shield 93, the cavity between the heat shield 93 and the first stator disk 85 is connected via the sector air ducts 95 to the air collector 96 of the brake cooling system. The air supply sector air ducts 82 and 95 are arranged uniformly about the circumference and situated between the brake cylinders 84. The air collectors 74 and 96, sector air ducts 82 with nozzle blades 86, sector air ducts 95 and brake cylinders 84 are made in the form of a monolithic assembly, installed on the stator 73 of each wheel. The nonrotating disk 109 with guide blades 110 is mounted on this monolithic assembly.

FIG. 14 shows the diagram of the air supply to a single-stage radial wheel turbine and axial wheel turbine, having opposite direction of rotation. The upper air collector 74 is connected by its sector air ducts 82 to the nozzle boxes 86 of the single-stage radial turbine, while the lower air collector 74 is connected by its sector air ducts 82 with sectors 83 to the nozzle boxes of the axial turbine. The nozzle boxes 86 are installed with a gap in front of the working wheel of the radial turbine with the blades 92. The blades 92 are installed between the disks 106 and 108, while the disk 108 is fastened to the rim 75 of the landing gear wheel. Unlike FIG. 12, here the nozzle blades and working blades are not separated by an intermediate wall into two flows and the working wheel of the radial turbine has only one direction of rotation.

The sectors 83 adjoin the first stator disk 85 of the wheel brake, in which as in all the others are constructed the sectors of the blade channels of the nozzle box of the axial turbine, uniformly arranged about the circumference. Unlike FIG. 10, here the nozzle blades and working blades are the usual kind, and not two-tiered, and the axial turbine has only one direction of rotation, opposite the direction of rotation of the radial turbine.

In the course of the movement of the airplane, the proposed device operates in the following modalities:

I. Acceleration of the airplane wheels before landing, during which the turbine is started to rotate the wheels in the direction of movement.
II. Turbine braking together with frictional braking.
III. Turbine braking without the frictional brake, wheel driven during forward or reverse movement.
IV. Brake cooling with no wheel driving or friction braking.

The described device with axial turbine, whose rotor disks are the working wheels, and whose stator disks are nozzle diaphragms, works as follows.

In modes I and III, high-pressure air from the onboard (or ground-based) source is supplied to the telescopic pipeline 65 of the landing gear. When the landing gear shock absorber 63 is operating, and the piston 64 of the shock absorber moves in the course of the movement of the airplane, the extensible pipe of the telescopic pipeline 65 moves along with it. Air from the telescopic pipeline 65 goes through pipe 72 to the air collector 7 of the landing gear. At a control signal, the valve 9 of corresponding direction of rotation of the wheel opens and air goes from the air collector 7 via the pipe 8 to the air collector 74. When the device shown in FIGS. 10 and 14 is operating, a control signal is also sent to the brake cylinders 84, as a result of which they compress the set of brake disks 85 and 87, so that minimal gaps are established between the stator disks 85 and the rotor disks 87, as shown in FIGS. 10, 14 and 15. The spring-loaded movable sectors 83 for air supply to the nozzle box press against the braking stator disk 85 of the wheel brake so that there is practically no leakage of air between them. In this case, the outer cylindrical part of the rotor disks 87 fit inside the rings 90 with a slight gap, so that the system of notches arranged about the circumference is located above the cylindrical part of the rotor disks 87. The rings 100 fit into the interior cylindrical part of the stator disks 85 with a slight gap, so that the system of notches 102 arranged about the circumference is situated inside the cylindrical part of the stator rings 85. This shuts off the free movement of high-pressure air between the brake disks.

Air from the air collector 74 goes by the sector air ducts 82 across the sectors 83 to the nozzle sectors of the first braking stator disk 85 and then to the working blades of the rotor disk 87. The process of air movement thereafter occurs as in an ordinary turbine. After exiting from the last rotor disk 87 in the path of movement of the air, the air goes through the exit guide vanes in the last stator disk 85 and enters the space between the set of brake disks and the disk part 103 of the wheel rim. The pressure in this cavity somewhat exceeds the atmospheric pressure, which enables movement of the air cooled upon expansion in the turbine across the slotted grooves 89 in the drum part of the wheel rim 75 and across the radial channels 105 and slotted grooves 98 in the brake body 99. This results in cooing of the tail portions of the brake disks. The air heated in the course of movement along the slotted grooves 98 does not make contact with the wheel stator 73, since it strikes against the annular heat shield 93, passes along it in the radial direction toward the disk rim and gets into the atmosphere.

For the device shown in FIG. 14, during frictional braking or reverse movement air gets into the axial braking. (reversing) turbine. For the case of an axial turbine with two-tiered blades, the air is supplied to the outer tier of the axial turbine. In the case of forward movement or acceleration of the wheels before landing, air is supplied to the inner tier of blades of the axial turbine, while for the device in FIG. 14 air is supplied in this case to the radial turbine.

In mode II of turbine braking together with frictional braking, a control signal is sent to the valve 9 and air from the air collector 7 goes via the pipe 8 to the air collector 74 of the upper tier of blades. A control signal is also sent to the brake cylinders 84, as a result of which they compress the set of brake disks 85 and 87, creating a braking moment thanks to friction forces, as shown in FIG. 16. In this case, the outer cylindrical part of the rotor disks 87 fits entirely inside the rings 90, while the rings 100 fit into the interior cylindrical part of the stator disks 85. The spring sectors 91 and 101 are compressed to the maximum. The air arriving in the upper tier of blades creates a rotational wheel braking moment, which is added to the frictional moment. The air cooled by expansion in the turbine moves through the slotted grooves 89 in the drum part of the wheel rim 75 and through the radial channels 105 and slotted grooves 98 in the brake body 99, cooling the tail pieces of the brake disks.

Brake cooling mode IV with no wheel driving or frictional braking occurs with the ejector operating and forcing cooling air through the disk brake. When the control signal is sent to the control valve 79, it opens and compressed air from the air collector 7 goes to the pipe 76 and via it to the nozzle of the ejector 77. The position of the brake disks at this moment is shown in FIG. 11 and corresponds to maximum axial gaps between the stator disks 85 and the rotor disks 87. The ejector 77 creates a rarefaction, as a result of which air from the brake cavity between the first stator disk 85 and the heat shield 93 moves through the system of pipes 94 along the sector air ducts 95 to the air collector 96 of the brake cooling system. Air from the air collector 96 goes by the pipe 78 to the inlet of the ejector 77 and from this it is ejected into the atmosphere. As a result, the brake disks are swept with atmospheric air, which during flight conditions may have a very low temperature. When the main engines are not operating, the cooling of the airplane brakes can be done while parked, thanks to the working of the APGU.

### EXAMPLE 6

### Parameters of the Axial Wheel Turbine

For the brake of the airplane II-96T/M, one can assume: outer diameter of the brake disks 464 mm, inner diameter 305 mm (S. S. Kokonin et al.), blade height of upper tier 10 mm, blade height of lower tier 10 mm, thickness of ring between blades 5 mm. The power of the frictional forces between stator disk and rotor disk can be represented as:

[equation]

where Ff is the friction force between disks, U(r) is the circumferential velocity of the rotor disk at radius r, while r1 and r2 are the inner and outer disk radius. One also calculates the loss of friction power due to lack of friction at the ring occupied by the turbine blades. The relative decrease in power of the friction brake can be estimated at 35%. We shall assume that the degree of pressure decrease in the wheel turbine is equal to 7. To obtain the permissible temperature behind the turbine of 120° C., the air temperature in front of the wheel turbine at turbine efficiency of 0.6 should be equal to ˜255° C. When the air for the landing gear turbines is prepared according to the diagram of FIG. 2 by means of a turbocompressor, whose inlet receives air from the fan duct, this means it is necessary to cool the air in front of the turbine of the turbocompressor by 175° C. The available thermal gradient in the turbine is equal to 137.3 kJ/kg.

For these dimensions and parameters, the power of the turbine of the upper duct for moderate axial flow velocities behind the turbine (300 ms) can be estimated at approximately 550 kW, which is 37% of the frictional brake power, i.e., the total brake power is in fact unchanged. But if a single-tier blade of height 25 mm is made in the brake disks, it would be possible already to obtain a turbine power of around 1400 kW, while the overall braking power (including the drop in frictional power) will be approximately equal to 2356 kW. This is 60% greater than the initial power. The air flow through the turbine will be around 10.05 kg/s. From the second duct of the engine, a flow rate of 17.0 kg/s is tapped for the three wheels of the landing gear, or 30.58 kg/s allowing for the tap to cool the air in front of the turbine of the turbocompressor, which constitutes around 1.35% of the flow rate in the fan duct. From the high-pressure tap, 13.58 kg/s is tapped for the turbine of the turbocompressor, which increases the flow rate of this tap by around 30%.

The calculations show that a greater power can be obtained in a multistage axial turbine than in a single-stage radial turbine or a radial turbine with speed stages.

1. A method of driving the wheels of an aircraft landing gear, characterized in that each wheel of the landing gear is rotated by means of one of two air turbines with opposite directions of turning, coaxial to the wheel, air whose pressure exceeds atmospheric pressure is fed from the main engines or from an auxiliary power plant of the aircraft to one of the air turbines, and the temperature in front of the turbine is maintained at a level so that the temperature of the air behind the turbine does not exceed the permissible strength of the materials of the wheel drum and tires.

2. The method of driving the wheels of an aircraft landing gear according to claim 1, further characterized in that air is supplied to the air turbine of each wheel from an ejector, taking in atmospheric air, into whose nozzle air is supplied whose pressure exceeds atmospheric pressure, from the main engines of the aircraft or from an auxiliary power plant.

3. The method of driving the wheels of an aircraft landing gear according to claim 1, further characterized in that air is supplied to the air turbines of the landing gear wheels or to the nozzle of an ejector from one of the taps of the compressors of the main gas turbine engines of the airplane.

4. The method of driving the wheels of an aircraft landing gear according to claim 1, further characterized in that air is supplied to the air turbines of the landing gear wheels from behind the fan of the main gas turbine engines of the airplane.

5. The method of driving the wheels of an aircraft landing gear according to claim 1, further characterized in that air is supplied to the air turbines of the landing gear wheels from a mixer, to which compressed air is supplied from the compressor and turbine of the turbocompressor, air is supplied to the compressor of the turbocompressor from behind the fans of the main turbofan engines, and air is supplied to the turbine of the turbocompressor from one of the high-pressure taps of the compressors of the main turbofan aircraft engines.

6. The method of driving the wheels of an aircraft landing gear according to claim 1, further characterized in that air is supplied to the air turbines of the landing gear wheels from a mixer, to which compressed air is supplied from the compressor and turbine of the turbocompressor, air is supplied to the compressor of the turbocompressor from one of the low-pressure taps of the compressors of the main gas turbine engines, and air is supplied to the turbine of the turbocompressor from one of the high-pressure taps of the compressors of the main gas turbine aircraft engines.

7. The method of driving the wheels of an aircraft landing gear according to claim 1, further characterized in that air is supplied to the air turbines of the landing gear wheels or to the nozzle of an ejector from the main supercharging line of piston aircraft engines.

8. The method of driving the wheels of an aircraft landing gear according to claim 1, further characterized in that that air is supplied to the air turbines of the landing gear wheels or to the nozzle of an ejector from an intermediate compression stage of the supercharging system of piston aircraft engines.

9. The method of driving the wheels of an aircraft landing gear according to claim 1, further characterized in that, upon approaching the landing, each wheel of the airplane is accelerated to a circumferential velocity at the tire rim equal to the aircraft speed, while control of the speed of angular rotation of the wheel is done by means of a control valve supplying air to the air turbine of the corresponding direction of rotation, at a signal put out by the onboard computer of the airplane upon comparison of the signals from the aircraft's speed sensor and the sensor of angular speed of rotation of the wheel, which signals go to the onboard computer.

10. An aircraft landing gear with wheel drive unit, composed of a shock absorbing strut, to whose shock absorbing piston is attached by a fastening bracket the landing gear rocker arm, with dampers and wheel axles mounted on it, with brake cylinder assemblies and wheels, in the drums of which are arranged the bodies of brakes with sets of brake disks, characterized in that a telescoping pipeline for supply of air to the landing gear wheels is secured to the shock absorbing strut of the landing gear, in parallel with it, the immovable part of which is secured by a bracket to the shock absorber, while its extending pipe, which is air-tight against the immovable part, is fastened by a bracket to the shock absorber piston, the telescoping pipeline at one end is connected to a source of compressed air on board the airplane, and at the other end to the air distributing collector of the landing gear wheels, to which are connected, by two offtake pipes for each wheel, on which control valves are mounted, annular wheel distributing collectors, not communicating by air, each of which is connected by sector air ducts to its radial or axial air turbine of the wheel drive unit, while the turbines have opposite directions of rotation; between the stator of the wheel and the first brake stator disk is installed an annular heat shield, by branch pipes uniformly distributed over the width of the air supply sector and installed in the stator and the heat shield the cavity between the heat shield and the first stator disk is connected by the sector air ducts to the air collector of the brake cooling system, while the annular wheel distributing collectors, the air collector of the cooling system, the sector air ducts and the brake cylinders are fabricated as a monolithic block, installed on the stator of each wheel, and openings uniformly spaced about the circumference are located in the disk part of the wheel rim, opposite the last stator disk.

11. The aircraft landing gear with wheel drive unit according to claim 10, further characterized in that the sector air ducts of the annular wheel distributing collectors of the axial turbine are connected to their set of spring-loaded air supply sectors, uniformly arranged about the circumference and constantly pressed against the first braking sector disk, which fit tightly into corresponding sector air ducts with ability to move parallel to the wheel axle together with the stator disk, opposite the air supply sectors in the adjacent and following braking stator disks, except for the last one, there are constructed through-channel sectors so that the stator disks constitute nozzle boxes of the axial turbine with partial air supply to the working wheels, in the last braking stator disk are constructed through channels so that the last stator disk constitutes an exit vortex gate with blades for partial air diversion from the last working wheel of the axial turbine, while the angular width of the blade sectors of the stator disks increases from one disk to another in the direction of air movement; in the rotor disks of the wheel brake are constructed through channels uniformly distributed about the circumference, so that the rotor disks constitute the working wheels of the axial turbine with blades situated opposite the corresponding nozzle blades of the stator disks.

12. The aircraft landing gear with wheel drive unit according to claim 11, further characterized in that openings uniformly spaced about the circumference are located in the disk part of the wheel rim, opposite the blade channels of the last stator disk.

13. The aircraft landing gear with wheel drive unit according to claim 10, further characterized in that the sector air ducts of the annular wheel distributing collector of the radial turbine are connected to their set of sectors of radial nozzle boxes, uniformly arranged about the circumference of their diameter, opposite which is mounted with a radial gap on the internal wheel rim the working wheel of a single-stage radial air turbine, or a multistage one with speed stages, while the nozzle boxes of the radial air turbine, and in the case of using a multistage radial air turbine with speed stages also the immovable wheels of the guide blades, are fastened to a monolithic block mounted on the stator of each wheel.

14. The aircraft landing gear with wheel drive unit according to claim 10, further characterized in that in the thrust end face of the brake body, adjacent to the last stator disk, there are radial end-face channels, forming with the surface of the stator disk a system of radial cooling channels, communicating with slotted grooves in the brake body.

15. The aircraft landing gear with wheel drive unit according to claim 10, further characterized in that between the rotor disks are installed cylindrical rings, so that the outer cylindrical part of the rotor disks fits inside the rings with a slight gap. On the outer cylindrical surface of the rings are mounted spring sectors, situated in slotted grooves of the drum portion of the wheel rim and abutting against the tail pieces of the rotor disks, while there are systems of identical notches uniformly arranged about the circumference at the lateral end faces of the rings.

16. The aircraft landing gear with wheel drive unit according to claim 10, further characterized in that between the stator disks are mounted cylindrical rings so that the fit into the internal cylindrical part of the stator disks with a slight gap, on the internal cylindrical surface of the rings are mounted spring sectors, situated in slotted grooves of the brake body and abutting against the tail pieces of the stator disks, and there are systems of identical notches uniformly arranged about the circumference at the lateral end faces of the rings.
